(19) United States
(12) Patent Application Publication
(10) Pub. No.: US 2006/0193000 A1
(43) Pub. Date: Aug. 31, 2006

(54) Print production system, print order receiver, and image forming apparatus and method

(75) Inventor: Jun Enomoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/360,529

(22) Filed: Feb. 24, 2006

(30) Foreign Application Priority Data
Feb. 25, 2005 (JP) 2005-050233
Mar. 14, 2005 (JP) 2005-070449
Mar. 14, 2005 (JP) 2005-070850

(51) Int. Cl. G06F 3/12

(52) U.S. Cl. 358/1.15

(57) ABSTRACT

In a print production system, when urgent finishing, in which print production is performed preferentially, is selected with a print order receiver having an urgent finishing selection function, information showing that the urgent finishing has been selected is given to order information and is outputted to an image forming apparatus together with the order information and the image forming apparatus outputs prints so that it is possible to identify that the prints correspond to the urgent finishing. A print order receiver includes a device, which computes a reception time for a placed print order from the contents of the print order, a print order status, and a printer status, and displays the reception time on a display. With an image forming apparatus and method, prints and a print pack are produced so that a print of a selected image is placed on the top of the print pack.

The entire contents of literatures cited in this specification are incorporated by reference.

### BACKGROUND OF THE INVENTION

The present invention relates to a print production system and a print order receiver for mainly receiving print orders (print production orders) for production of prints from images photographed with digital cameras or the like and an image forming apparatus and method for mainly performing production of prints from images photographed with cameras or the like. More specifically, the present invention relates to a print production system for making it possible to provide prints to customers swiftly after reception of print orders, a print order receiver that allows customers to know print reception times appropriately, and an image forming apparatus and method for automatically packing prints and allowing the packed prints to be distinguished with ease.

Digital cameras have come into more widespread use along with the popularization of a personal computer (PC), a personal digital assistance (PDA), or the like. A cellular phone having a photographing function has also become popular.

In general, images (image data) photographed with a digital camera, a cellular phone, or the like are inputted into a PC or the like to be processed, and then used for various applications such as website creation or new year greeting card creation. However, there is also a strong demand for preserving such photographed images as high-quality (photographic) prints. Meanwhile, a so-called digital mini-laboratory has been put into practical use which photoelectrically reads images photographed on a film with a CCD sensor or the like, generates output images (data) by performing predetermined image processing on the read images (image data), scan-exposes printing paper with recording light, such as laser light, which has been modulated in accordance with the output images, and performs predetermined wet processing on the exposed printing paper. The digital mini-laboratory that deals with images as image data is capable of coping also with production of prints from images photographed with a digital camera or the like with ease.

Under such circumstances, specialized venders of laboratories or the like have recently started to produce prints from images photographed with a digital camera or a cellular phone by using such the digital mini-laboratory.

When an order for producing prints from images photographed with a digital camera is placed with a print vender, for example, a print order receiver (hereinafter referred to as “receiver”) installed in a store such as a laboratory, various commercial facilities, or the like is used to place the order.

Generally, when a recording medium such as a memory card, an IC card, or a CD-R for storing photographed images is loaded on the receiver, or a digital camera or a cellular phone is connected to the receiver directly or by using connection means, the receiver reads the images and displays the images together with an order screen on a display.

A customer (print orderer) inputs order information including images to be printed, print sizes, the number of prints for each image, and the like by using a touch panel display or a predetermined inputting method. When the order is established, the images and information relating to the inputted order (order information) are related to each other and sent to, for example, a sever or an image processor of a laboratory, and the images are supplied therefrom to a digital photo printing system such as the digital mini-laboratory, where prints are produced in accordance with the order information, and the produced prints are outputted.

By the way, such production of prints from images photographed with a digital camera or the like does not involve film development processing, so print production work is simplified and swift print production becomes possible. Also, acceleration of the processing by the digital mini-laboratory and improvement of processing accuracy, workability, and the like of the digital mini-laboratory have been achieved. Further, as described in JP 2004-310061 A and the like, techniques for achieving acceleration of exposed printing paper development processing and the like have been developed.

Against this backdrop, in the case of production of prints from images photographed with a digital camera or the like, as compared with a case of ordinary production of prints from a film, it becomes possible to significantly shorten a time required to provide prints to a customer after reception of a print order.

Also, in the conventional production of prints from a photographic film or the production of prints from images photographed with a digital camera or the like, after a print order has been received from a customer in a store such as a laboratory, production of prints from photographed images is performed and prints outputted as product prints are accumulated in a sorter of a photo printer or the like and then put in a DP bag by an operator through manual work. Then, before the prints are delivered to the customer, at least one or a plurality of the prints is shown to the customer in order to confirm that the prints belong to the customer. However, this method is ineffective because the operator needs to process the print order at much expense in time and effort.

In order to simplify the work, a so-called “packer” is proposed. The packer collectively puts prints accumulated in a sorter of an image forming apparatus or the like in a transparent bag and closes the bag containing the prints through sealing or the like. In this case, however, the prints are contained in the bag, so it is impossible to show some prints to a customer for confirmation. In view of this problem, a print, on which order contents (such as a customer name, a print ID, order information, a fee, and a barcode) have been recorded, is placed on the top of the accumulated prints, thereby making it possible to confirm the order contents, the fee, and the like with ease even under a packed state.

Also, generally, when a customer receives prints corresponding to the customer's print order in a store such as a laboratory, the customer hands a claim check to a salesclerk. The salesclerk finds the corresponding prints from among many finished prints based on a reception number or the like written on the claim check, and delivers the found prints to the customer.

As described above, in the case of the production of prints from images photographed with a digital camera or the like, as compared with the conventional production of prints from a photographic film, it becomes possible to complete the print production extremely swiftly. Therefore, there is a possibility that it become possible to provide a service in which, for instance, immediately after a customer has placed a print order using a receiver installed in a store, prints are produced and delivered to the customer on the spot by processing the print order through preferential processing such as interrupt processing.

Here, in order to provide such a service, it is required to speedily select and extract the prints of an order that need to be handed to the customer from among prints of many orders after the print production.

With an ordinary photo printer, however, prints are sequentially outputted to respective bins of a sorter in the order of print production, so when there exist prints of many orders, it is impossible to know which order needs to be delivered to the customer urgently, which leads to a problem that it is impossible to select and extract prints of necessary order without delay.

Also, under present circumstances, it is impossible for a receiver to grasp a print reception time (time at which prints are finished and can be provided to a customer), which makes it impossible to inform the customer of the print reception time. Accordingly, there is a problem in that even when the print order is processed in the store swiftly immediately after the customer has placed the print order using the receiver installed in a store and the prints are finished to be ready for deliver, it is impossible for the customer to receive the prints on the spot.

Therefore, there is a problem in that it is required for the customer to revisit the store to receive the prints after a time, which is considered to be sufficient for completion of print production, has passed or at a later date.

In addition, with the method described above, when the number of finished prints put on a shelf is large, it is difficult to find necessary prints through checking of a customer name, a reception number, or the like. Therefore, as a labor-saving method, a method is also conceivable with which a customer finds ordered prints by himself/herself from among many finished prints put on a shelf, brings the found prints as well as a claim check to a checkout counter, and makes a payment at the counter. However, the method has a problem in that it is not easy for the customer to find his/her ordered prints through checking of a customer name, a reception number, or the like. Further, it is necessary for a staff member in a store to arrange finished prints on the shelf in the order of reception numbers or the like at much expense in time and effort in order to make the customer find his/her ordered prints with ease. In this case, a method is also conceivable with which product prints are packed so that one of the product prints is stacked on the top of a print pack. However, the method has a problem in that the top print may be seen by others on the shelf and therefore it is difficult to say that customer privacy can be protected.

### SUMMARY OF THE INVENTION

A first object of the present invention is to solve the problems of the conventional techniques described above and to provide a print production system. In the print production system, print orders for production of prints from images (image data) photographed with a digital camera, a cellular phone having an imaging function, or the like are placed using a print order receiver and it is possible to easily identify, select, and extract prints of an order which needs to be immediately produced and delivered to a customer, that is, requires swift handling. Therefore, the print production system can realize an urgent finishing service, in which ordered prints are provided on the spot with a slight waiting time after an order reception, for example.

Also, a second object of the present invention is to solve the problems of the conventional techniques described above and to provide a print order receiver. The print order receiver allows a customer to know a print reception time when the customer places a print order for production of prints from images (image data) photographed with a digital camera, a cellular phone having an imaging function, or the like using the print order receiver, and, if possible, allows a customer to receive prints on the spot, at a nearby reception counter or the like with a short waiting time.

Further, a third object of the present invention is to solve the problems of the conventional techniques described above and to provide an image forming apparatus including a packer and method with which when prints are packed using a packer, a print placed on the top of accumulated prints is processed so as to enable a customer to find a print pack corresponding to his/her order with ease while protecting customer privacy.

In order to achieve the above first object, a first aspect of the present invention provides a print production system, including:

a print order receiver that includes image acquiring means for acquiring first image data and input means for inputting print orders each of which is made for print production of one or more frame images of second image data among the first image data, wherein the print order receiver relates, for each print order, order information corresponding to a print order input by the input means and the second image data of the one or more frame images to each other and outputs the second image data and the order information related to each other, as well as the print order receiver has a function of selecting urgent finishing in which the print production is performed preferentially, and, when the urgent finishing is selected and outputs urgent finishing information showing that the urgent finishing has been selected by giving the urgent finishing information to the order information; and

an image forming apparatus that includes means for receiving the second image data and the order information related to each other for each print order from the print order receiver, means for performing the print production corresponding to the received order information using the received second image data, an output section for outputting one or more produced prints by the performing means, and means for enabling to identify the one or more produced prints of the print order as the urgent finishing when the one or more produced prints of the print order corresponding to the urgent finishing is output to the output section.

In the print production system according to the first aspect of the present invention, preferably, the output section of the image forming apparatus includes a first output section for the urgent finishing and a second output section for ordinary finishing, and the enabling means allows to output the one or more produced prints of the print order corresponding to the urgent finishing to the first output section for the urgent finishing, thereby enabling to identify the print order as the urgent finishing. In this case, preferably, the image forming apparatus further includes a sorter for sorting one or more produced prints for each print order and outputting the sorted produced prints and a packer for bundling and packing the one or more produced prints for each print order and outputting the bundled and packed produced prints, and the first output section for the urgent finishing is the packer and the second output section for the ordinary finishing is the sorter.

Also, preferably, the image forming apparatus further performs print production of an identification print for identifying as the urgent finishing in case of the print order corresponding to the urgent finishing, and the enabling means allows to output the identification print which shows that the urgent finishing has been performed together with the one or more produced prints of the print order corresponding to the urgent finishing, thereby enabling to identify the print order as the urgent finishing. Moreover, preferably, the image forming apparatus further includes a packer for bundling and packing one or more produced prints for each print order and outputting the bundled and packed produced prints, and the packer uses a first packing bag for the one or more produced prints of the print order corresponding to the urgent finishing and a second packing bag for the one or more produced prints of the print order corresponding to ordinary finishing, which are different from each other, and the enabling means allows to output the first packing bag in which the one or more produced prints of the print order corresponding to the urgent finishing are bundled and packed and which is different from the second packing bag, thereby enabling to identify the print order as the urgent finishing.

Further, preferably, print production system plural print order receivers includes the print order receiver and one or more print order receivers having a configuration as same as the print order receiver and each of the plural print order receivers outputs identification information for identification of itself by giving the identification information to the order information, wherein the image forming apparatus outputs the one or more produced prints of the print order corresponding to the urgent finishing to the output section using the identification information so that one print order receiver that have received the print order corresponding to the urgent finishing can be distinguish from the remainder of the plural print order receivers.

Also, in order to achieve the above first object, a second aspect of the present invention provides a print production system, including:

plural print order receivers, each including image acquiring means for acquiring first image data and input means for inputting print orders each of which is made for print production of one or more frame images of second image data among the first image data, wherein the print order receiver relates, for each print order, order information corresponding to a print order input by the input means and the second image data of the one or more frame images to each other and outputs the second image data and the order information related to each other; and

an image forming apparatus that includes means for receiving the second image data and the order information related to each other for each print order from the print order receiver, means for performing the print production corresponding to the received order information using the received second image data, and an output section for outputting one or more produced prints by the performing means,

wherein each print order receiver outputs identification information for identification of itself by giving the identification information to the order information, and

wherein the image forming apparatus outputs the one or more produced prints of the print order to the output section using the identification information so that one print order receiver that have received the print order can be distinguish from the remainder of the plural print order receivers.

Also, in order to achieve the above second object, a third aspect of the present invention provides a print order receiver that is connected to at least one other print order receiver and at least one printer for performing production of one or more prints, including:

image acquiring means for acquiring first image data;

input means for inputting print production orders, each of which is made for print production of one or more frame images of second image data among the first image data;

information acquiring means for acquiring a print order status by the at least one other print order receiver connected and a print production status of the at least one printer connected;

computing means for computing, for each print order, a reception time at which the one or more produced prints corresponding to the print production order is receivable based on a content of each of the print production orders, the acquired print order status by the at least one other print order receiver, and the acquired print production status of the at least one printer; and

a display for displaying the computed reception time.

Preferably, the print order receiver according to the third aspect of the present invention, further includes: selection means for selecting one of ordinary finishing and urgent finishing in which the print production is performed preferentially as compared with one or more print production orders of the ordinary finishing that are input at an earlier time. Moreover, preferably, after the print production order is input by the input means, processing for establishing the print production order is performed, and during a period from completion of the inputting of the print production order to the establishing of the print production order, the reception time is updated in accordance with the acquired print order status by the at least one other print order receiver and the acquired print production status of the at least one printer. Further, preferably, while the print production order is waiting, the computing means predicts a provisional print reception time from the acquired print order status by the at least one other print order receiver and the acquired print production status of the at least one printer and displays the predicted provisional print reception time on the display.

Further, in order to achieve the above third object, a fourth aspect of the present invention provides an image forming apparatus, including:

an image forming section for producing one or more prints by recording one or more images on a recording medium in accordance with image data; and

a packer for producing a print pack by bundling and packing one or more produced prints for each order,

wherein print production by the image forming section and print pack production by the packer are controlled so that a print on a top in the print pack becomes a print on which a selected image has been recorded.

In the image forming apparatus according to the fourth aspect of the present invention, preferably, the selected image is an image selected from among images in one print order in which production of the one or more prints is ordered. Alternatively, preferably, the selected image is an image selected from among not images in print orders in which the print production is ordered but images prepared in advance. Still alternatively, preferably, the selected image is an image whose human subject face area is smallest among images containing human subjects in one print order in which production of the one or more prints is ordered.

Also, preferably, the selected image is an image which is selected from among images in one print order in which production of the one or more prints is ordered and does not contain a human subject. Alternatively, preferably, the selected image is an image obtained by blurring an index image of one print order in which production of the one or more prints is ordered.

Further, preferably, an image having undergone processing is recorded on the top print. Moreover, in order to reduce consumption of paper, preferably, the top print is a product print.

Also, preferably, the image forming apparatus according to the fourth aspect of the present invention, further including: a print order receiver that receives print production orders, wherein the image forming section produces the one or more prints by recording image data supplied from the print order receiver, and wherein the print order receiver includes means for selecting an image to be recorded on the top print in the print pack and means for outputting a hard copy on which the image is recorded.

Also, a fifth aspect of the present invention provides an image forming method, including the steps of:

producing one or more prints by recording one or more images on a recording medium in accordance with image data; and

producing a print pack by bundling and packing one or more produced prints for each order,

wherein a print on a top in the print pack becomes a print on which a selected image has been recorded.

According to the first aspect of the present invention described above, when placing a print order with the print order receiver, it is possible to easily identify, at the print output unit, an order designating urgent finishing in which print production is performed preferentially as compared with other orders. Thus, the order can be extracted swiftly from among many orders. Therefore, according to the present invention, it becomes possible to realize an urgent finishing service, in which ordered prints are provided to a customer on the spot with a slight waiting time after an order reception, or the like.

Also, according to the first and second aspects of the present invention, in a case where the print production system includes multiple print order receivers, it is preferable that a print order receiver that has received an order be identified at the print output part, which enables a swifter print extraction.

Further, according to the third aspect of the present invention described above, a customer (print orderer) can know a print reception time (time at which prints are finished and can be provided to the customer) when the customer places a print order using the print order receiver. Accordingly, the customer can determine in accordance with the reception time whether to wait on the spot until the prints are finished and delivered or to revisit a store at a later time, which eliminates a necessity for the customer to revisit the store at a later time.

In addition, a selection between ordinary finishing and urgent finishing in which an order is processed while getting ahead of other orders placed before the order within a possible range, is made possible and a fee for the urgent finishing is set higher than that for the ordinary finishing, so a customer can make a service selection in consideration of a reception time and a fee, which further improves customer's convenience.

Still further, according to the fourth and fifth aspects of the present invention described above, the packer of the image forming apparatus packs prints so that a print of an image appropriately selected in advance is stacked on the top of the packed prints. Thus, it is possible to pack the prints in such a manner that a customer can distinguish prints corresponding to his/her order at a glance. In addition, when the image of the top print is appropriately selected by the customer in advance or image processing is further performed on the image to make it impossible to clearly understand the contents of the image, it is also possible to protect customer privacy. Also, a staff member in a store can put print packs on a shelf without considering an arrangement order, which increases working efficiency.

### BRIEF DESCRIPTION OF THE DRAWINGS

In the accompanying drawings:

FIG. 1 is a block diagram conceptually showing an embodiment of a print production system according to the present invention;

FIG. 2 is a perspective view conceptually showing an external appearance of an embodiment of a print order receiver used in the print production system shown in FIG. 1;

FIG. 3 is a diagrammatically illustrated cross-sectional view conceptually showing an embodiment of an image forming apparatus of the print production system shown in FIG. 1;

FIG. 4 is a diagrammatically illustrated cross-sectional view conceptually showing another embodiment of the image forming apparatus that is usable in the print production system according to the present invention;

FIG. 5 is a block diagram conceptually showing a construction of a part of the embodiment of the print order receiver shown in FIG. 2;

PIG. 6 is a flowchart for explanation of an example of an operation of the print order receiver shown in FIGS. 2 and 5;

FIGS. 7A, 7B, and 7C are respectively a conceptual diagram showing an example of a standby screen of the print order receiver shown in FIGS. 2 and 5, a conceptual diagram showing another example of the standby screen, and a conceptual diagram showing an example of an order confirmation screen of the print order receiver;

FIG. 8 is a block diagram conceptually showing an embodiment of a print production system that uses the image forming apparatus according to the present invention;

FIG. 9 is a diagrammatically illustrated cross-sectional view conceptually showing an embodiment of a packing function-equipped mini-laboratory of the print production system shown in FIG. 8;

FIG. 10 is a schematic perspective view of an example of a packing sheet used in the mini-laboratory shown in FIG. 9; and

FIGS. 11A and 11B are each a conceptual diagram showing an example of a print placed on the top of a print pack produced by the mini-laboratory shown in FIG. 9.

### DETAILED DESCRIPTION OF THE PREFERRED EMBODIMENTS

The print production system according to the first and second modes of the present invention, the print order receiver according to the third mode of the present invention, the image forming apparatus according to the fourth mode of the present invention, and the image forming method according to the fifth mode of the present invention will be described below in detail based on the preferred embodiments with reference to the accompanying drawings.

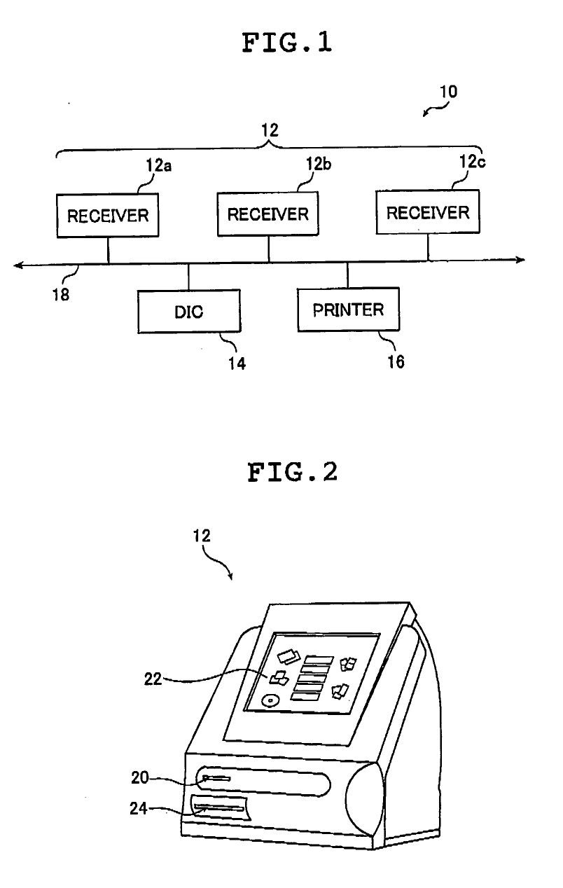

First, the print production system according to the first and second modes of the present invention will be described with reference to FIGS. 1 to 4.

FIG. 1 is a block diagram conceptually showing an embodiment of the print production system according to the present invention.

A print production system (hereinafter referred to as the “production system”) 10 in an illustrated example is a system that produces (photographic) prints, which correspond to orders placed by a customer (order information provided by the customer), from images (image data) photographed with a digital camera, a cellular phone, or the like, and includes print order receivers (hereinafter referred to as the “receivers”) 12, a digital image controller (hereinafter referred to as the “DIC”) 14, and a printer 16, for instance. These are connected to each other through a known network 18, thereby enabling, for example, mutual browsing or transmission/reception of information or the like. Note that the DIC 14 and the printer 16 constitute the image forming apparatus used in the present invention.

It should be noted that in the illustrated example, the production system 10 includes three receivers 12 (12a, 12b, and 12c) but the number of the receivers 12 in the print production system that uses the receiver according to the present invention is not limited to three and may be decreased to one or two or increased to four or more. Also, there occurs no problem even when the production system 10 includes multiple DICs 14 and/or multiple printers 16.

FIG. 2 is a conceptual perspective view of an external appearance of an embodiment of the receiver 12.

The receiver 12 is installed in a laboratory, commercial facilities, or the like and receives an order for print production of at least one frame image selected from among one or multiple (ordinarily, many) frame images (image data) photographed with an imaging device such as a digital camera and a cellular phone having a photographing function. The receiver 12 includes a loading unit 20 into which a storage medium (storage media) is loaded, a display 22 for displaying various screens, receiving orders inputted through an order screen and performing other operations, and a reception slip output unit 24. In addition, the receiver 12 also includes a display controller for controlling the display 22, a media drive (media driver) for reading/recording image data (recording data) from/into the storage medium loaded into the loading unit 20, a printer for creating print order reception slips (claim checks) and outputting the slips from the reception slip output unit 24, a CPU for performing computation, control, and the like to achieve various functions of the receiver 12, and a ROM and a RAM in which various information items that the CPU uses to perform the computation and control are stored.

The receiver 12 is basically a known print order receiver except that it has a function of making a selection between ordinary finishing and urgent finishing to be described later. Therefore, the receiver 12 reads images (image data) from the storage medium loaded into the loading unit 20 using the media driver. Then, the receiver 12 relates information (order information) (order data) which was inputted through a display screen on the display 22 and concerns a print order and the images (order images) (image data) corresponding to one order to each other using the CPU or the like, and outputs and supplies them to the DIC 14. For instance, the receiver 12 generates thumbnail images of the frame images corresponding to the one order from the image data read from the storage medium and displays the generated thumbnail images in a display screen on the display 22. Next, a user or an operator inputs a print size, the number of prints to be made, a finishing surface type (glossy, half-glossy, non-glossy (mat), or silky, for instance), a reception method, and the like for each displayed thumbnail image through a touch panel on the display screen. Then, the CPU or the like in the receiver 12 generates individual order information (data) showing the print size, the number of prints to be made, the finishing surface type, the reception method, and the like inputted for each displayed thumbnail image, relates the individual order information to image data corresponding to the frame image of each displayed thumbnail image, and outputs them to the DIC 14. As means of the receiver 12 for relating the order information (data) and the image data to each other, for instance, it is possible to use means for relating order information (data) of one order which includes all pieces of individual order information for all frame images in the one order and image data of the one order which includes all pieces of image data of the all frame images in the one order to each other by writing information about a link to a file of the individual order information of each frame image in a header or the like of the corresponding image data, or by directly writing the individual order information of each frame image in a header or the like of the corresponding image data.

There is no particular limit on the storage medium accepted by the receiver 12 (that is, the drive) according to the present invention and known storage media, such as SmartMedia™, CompactFlash™, Memory Stick™, SD Memory Card™, a PC Card, a CD-R, and an MD, are all usable. Needless to say, the storage medium accepted by the receiver 12 is not limited to one type and multiple types of storage media may be accepted.

Also, the receiver 12 may read images directly from a digital camera, a cellular phone, or the like using predetermined connection means or the like.

In the illustrated example, the display 22 serves as a so-called touch panel, with which an operator performs various operations, and functions also as input means and operation means for allowing the operator to perform various operations, such as various kinds of input (input of images to be printed, the numbers of prints to be made, the sizes of the prints, and the like) and an instruction input for selection between ordinary finishing and urgent finishing to be described later, using a known graphical user interface (GUI) realized by displaying images on the display 22.

It should be noted that the receiver 12 is not limited to the form in which the input operations are performed on the display 22. For instance, the input operations may be performed using operation means such as a mouse, a keyboard, or an operation button. Alternatively, the input operations may be performed using the display 22 and the operation means in combination.

Here, the production system 10 is a system in which it is possible to make a selection between ordinary finishing in which print production is performed in an ordinary manner and urgent finishing, and the selection between the ordinary finishing and the urgent finishing can be made at the receiver 12 concurrently with print order input.

The urgent finishing is a service in which print production is performed preferentially as compared with an order of the ordinary finishing and prints are provided swiftly. For instance, in the case of an order designating the urgent finishing, the order is processed prior to other orders designating the ordinary finishing which were placed before the order far the urgent finishing (that is, while getting ahead of the other orders) within a possible range, and prints are produced and outputted with a shortest waiting time within a possible range, thereby making it possible to immediately provide the prints to a customer, who is waiting for the prints to be finished on the spot (or at a predetermined position close to the receiver 12) after having placed the order, with a several-minute to ten-minute waiting time after the order placement. Here, in the production system 10, it is preferable that a fee for the urgent finishing be set higher than that for the ordinary finishing. In addition, the amount of the fee may be changed in accordance with a finish time.

It should be noted that the receiver 12 may not particularly include ordinary finishing selection means and may only include urgent finishing selection means. In this case, each order designating the urgent finishing may be processed by performing the urgent finishing and each order that does not designate the urgent finishing may be processed by performing the ordinary finishing.

In response to a print order of one order inputted using the display 22, the receiver 12 generates an order ID (identification information) for the one order, processes the inputted print instruction, relates order information and the images (image data) to each other, and outputs them to the DIC 14 through the network 18. The order information shows the order ID, images (image IDs) whose prints are to be produced, the numbers of the prints, the sizes of the prints, a predicted finish time, whether the urgent finishing or the ordinary finishing has been selected, and the like. In addition, in the illustrated example, as a preferable form, the receiver 12 adds identification information for identification of itself (that is, in the illustrated example, identification information of the receiver 12a, identification information of the receiver 12b, or identification information of the receiver 12c) to the order information.

It should be noted that the predicted finish time is calculated by the DIC 14 to be described later from a status of the production system 10 and is supplied to a corresponding receiver 12 (12a, 12b, or 12c). In addition, only when the urgent finishing has been instructed, the receiver 12 may add information showing that the urgent finishing has been instructed to the order information, and when the ordinary finishing has been instructed, the receiver 12 may not add such information to the order information. In this case, in the production system 10, each order, for which the urgent finishing has not been instructed, may be processed by performing the ordinary finishing.

At the receiver 12, when an order has been established, a reception slip, on which a reception ID, the numbers of prints to be made, a fee, and the like have been recorded, is created and outputted from the reception slip output unit 24. The reception slip may be set as a receipt or a claim check.

There is no particular limit on the printer that creates the reception slip and it is sufficient that a known printer, such as an ink jet printer or a thermal printer, which is used in a photograph order receiver or the like installed in a store or the like is used.

The receiver 12 is not limited to a dedicated receiver installed in a store and the like and may be a device that is applicable to a so-called Internet order in which a print production orders are placed using a personal computer (PC) at home or the like through a computer communication network such as the Internet, an e-mail order from a camera-equipped cellular phone, or the like. In other words, a PC of the customer at home, a cellular phone, or the like may function as the print order receiver in the production system 10. In this case, for instance, the PC or the like may function as the print order receiver of the present invention by accessing and browsing a laboratory website or the like. Alternatively, the PC or the like may function as the print order receiver in the production system 10 by executing dedicated ordering software downloaded/installed thereinto/thereonto.

Also, a PC in a laboratory may function as the print order receiver in the system 10 by executing dedicated order receiving software installed thereonto.

The DIC 14 generates output images (reproduction image data) for print production by the printer 16 by performing predetermined image processing on respective images supplied from the receiver 12, relates the output image of each frame image and corresponding order information to each other for each order, and supplies them to the printer 16. Also, after having sent out all frame images and the order information of the all frame images corresponding to one order, the DIC 14 further supplies sort information indicative of the end of one order to the printer 16.

The image processing carried out by the DIC 14 is not specifically limited, and it is possible to use various known image processing such as image enlargement/reduction (electronic magnification), gradation correction, color/density correction, color saturation correction, and sharpness processing. Also, it is sufficient that each image processing described above is executed with a known method.

Here, in the production system 10, images and order information corresponding to orders received by all receivers 12 are gathered to the DIC 14. The DIC 14 determines a processing order for the orders in consideration of predicted finish times, and sequentially outputs the output images and the order information of each order to the printer 16 in accordance with the determined order. Also, the DIC 14 determines the processing order so that each order designating the urgent finishing is preferentially processed while getting ahead of other orders designating the ordinary finishing, and prints corresponding to the order designating the urgent finishing are finished with the shortest waiting time as long as prints corresponding to the other orders designating the ordinary finishing can be finished on time.

Further, the DIC 14 computes predicted print finish times from the number of images that the DIC 14 holds, the print sizes of the images, order information from the receivers 12, an operating status of the printer 16, a processing capability (number of prints that are outputtable per unit time) of the printer 16, and the like, and supplies the computed predicted print finish times to the receivers 12. For each order designating the urgent finishing, the DIC 14 computes the predicted finish time so that prints corresponding to the order designating the urgent finishing are finished with the shortest waiting time as long as prints corresponding to other orders designating the ordinary finishing can be finished on time like in the case of the processing order determination.

It should be noted that in the case where multiple printers 16 are connected to the production system 10, the DIC 14 may make printer selections for image output in consideration of reception time of each order, the operating statuses of the printers 16, and the like.

Also, in this case where multiple DICs 14 are connected to the production system 10, one of the DICs 14 acquires information from all other DICs 14 and performs management and control of processing of all orders, the determination of the processing order, the computation of the predicted finish times, and the like.

In the production system 10 in the illustrated example, when orders designating the urgent finishing have been placed, the printer 16 to be described later automatically packs produced prints and outputs them as a print pack in units of orders.

Here, as a preferable form, for the order designating the urgent finishing, the DIC 14 produces an image (order print image) of an order print, which shows various kinds of information concerning the order (such as an order ID, a print fee, and the numbers of prints), and supplies the order print image to the printer 16 together with images corresponding to the order. In addition to the information described above, a notification that the urge finishing has been designated can also be written on the order print image and it is preferable that information showing the receiver 12 that has received the urgent finishing order be further recorded on the order print image based on the identification information of the receiver 12 included in order information.

Also, in the production system 10, not the receiver 12 but the DIC 14 may acquire image data from a storage medium or the like and receive input of print order information. Even in this case, like in the case described above, the DIC 14 generates print images by performing image processing corresponding to order data on the acquired images and supplies the print images to the printer 16.

That is, in this case, the DIC 14 functions as the print order receiver constituting the system according to the present invention.

The printer 16 is the image forming apparatus according to the present invention and produces (finished photographic) prints by imagewisely exposing a photosensitive material (printing paper) in accordance with print images (and an order print image) and order information supplied from the DIC 14 to form latent images, performing predetermined wet development processing on the exposed photosensitive material, and drying the developed photosensitive material.

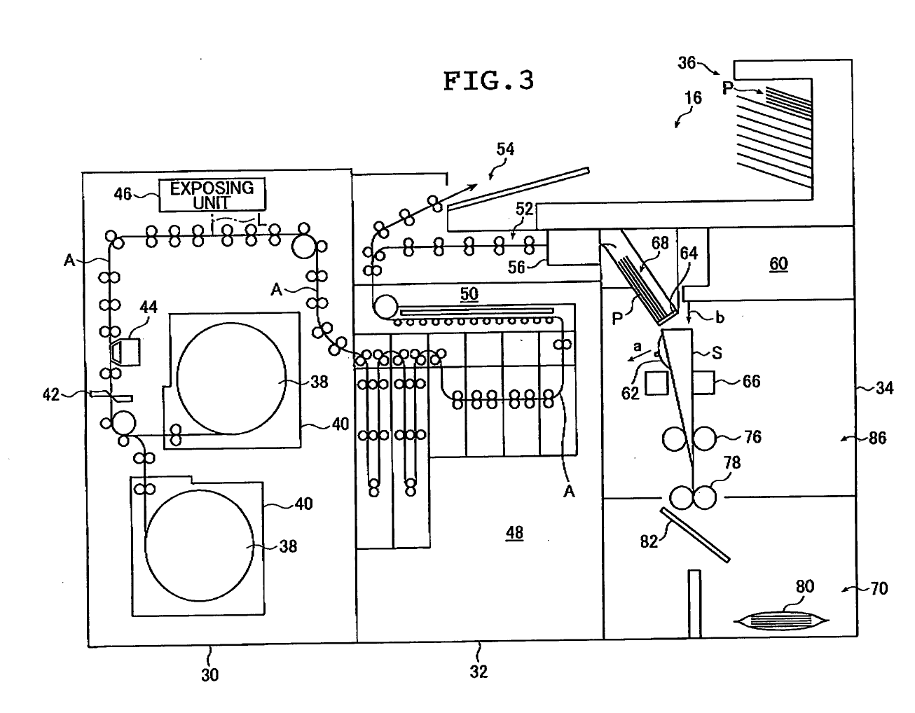

FIG. 3 is a diagrammatically illustrated cross-sectional view of an embodiment of the printer used in the print production system shown in FIG. 1. As shown in FIG. 3, the printer 16 includes an exposure part 30, a processor 32, a packer 34, and a sorter 36. In brief, a photosensitive material A is conveyed to each part by known conveying means such as carrier roller pairs.

In the printer 16 in the illustrated example, two magazines 40 each accommodating a photosensitive material roll 38 obtained by rolling up the photosensitive material A are loadable into the exposure part 30.

The photosensitive material A is pulled out of the magazines 40 to be cut into a print size by a cutter 42 and is supplied to a predetermined exposing position after recording of a back print by a back printer 44.

Images (print images and order print image) supplied from the DIC 14 are supplied to an exposing unit 46.

The exposing unit 46 brings an optical beam L (recording light) modulated in accordance with the images into incident at the exposing position by deflecting the optical beam L in a main scanning direction. On the other hand, the photosensitive material A is conveyed for scanning in an auxiliary scanning direction orthogonal to the main scanning direction to pass through the exposing position. Accordingly, the photosensitive material A is two-dimensionally scan-exposed by the optical beam L modulated in accordance with the images and latent images are recorded on the photosensitive material A. The photosensitive material A, on which the latent images have been recorded, is sequentially supplied to the processor 32.

The processor 32 includes a developing part 48 and a drying part 50.

The photosensitive material A, which has the latent images formed thereon at the exposure part 30 and has been supplied to the processor 32, is first conveyed to respective processing vessels of the developing part 48 in which the photosensitive material A is subjected to development processing, beaching/fixing processing, and water washing processing in succession. Next, the photosensitive material A is dried by a heater or the like at the drying part 50.

The (finished photographic) prints P after the drying are conveyed to a conveyance switching part 56 through a conveying part 52. Then, prints P obtained as a result of the ordinary finishing are conveyed from the conveyance switching part 56 to the sorter 36 and prints P obtained as a result of the urgent finishing are conveyed from the conveyance switching part 56 to the packer 34. Note that the present invention is not limited to this and, conversely, the urgently finished prints P may be outputted to the sorter 36 and the ordinarily finished prints P may be outputted to the packer 34.

The conveyance switching part 56 is known sheet-shaped matter conveying path switching means and switches a print P conveying path between a path directed toward the upper sorter 36 and a path directed toward the lower packer 34 (extending straight) using a known method or means, examples of which are conveying path switching means, such as a flapper or a switching guide, and a guide member.

It should be noted that large-sized prints P that exceed a predetermined size, such as an A4 size, are discharged to a large size print discharging part 54 located above without being conveyed through the conveying part 52. It is sufficient that conveying path switching for the discharge to the large size print discharging part 54 is also performed with a known method or means using a flapper, a switching guide, or the like.

The sorter 36 is a known sorter including means for conveying the prints P, multiple bins, means for switching discharge of prints to the bins, and the like and fitted to various photo printers.

The ordinarily finished prints P are conveyed from the conveyance switching part 56 to the sorter 36, at which the prints P are sorted in units of orders in accordance with sort information and order information from the DIC 14 and the like and are discharged to the bins.

On the other hand, the packer 34 is known sheet-shaped matter packing means, and accumulates and packs prints P corresponding to urgent finishing orders in units of orders in accordance with order data. Therefore, the packer 34 includes a sheet supply unit 60 for supplying packing sheets S, a packing unit 86 including opening means 62, a stopper 64, a sealing/cutting unit 66 and an accumulating unit 68, and a product receiving unit 70.

Also, in the packer 34, in addition to the illustrated members, various members, such as a packing sheet S guide member, a supporting/holding member, and packing sheet S (print pack 80) conveying means, are disposed as necessary.

The packing sheet S is an individual square-tube-shaped transparent bag matter, whose one end is opened and the other end is closed. The packing sheet S is used to produce the print pack 80. Many packing sheets S are loaded into the sheet supply unit 60. By known sheet-shaped matter conveying means, each packing sheet S is extracted from the sheet supply unit 60 and is conveyed in a direction indicated by an arrow b in FIG. 3 to be supplied to a position so that its open end is positioned below the accumulating unit 68 to be described later. At the position, the packing sheet S is held by holding means (not shown), for instance, with its upper right and left ends nipped under a state in which a distance between the right and left ends is somewhat reduced from its width (width of the upper open end).

Next, the opening means 62 opens the packing sheet S by moving in a direction (direction of an arrow a in FIG. 3) that opens the packing sheet S, while holding the packing sheet S (by suction or the like). Further, preferably, wind is blown from above by a fan, thereby inflating the packing sheet S.

Prints P corresponding to urgent finishing orders are supplied from the conveyance switching part 56 to the accumulating unit 68. The accumulating unit 68 has a downwardly inclined slope, and the stopper 64 at the lower end portion of the accumulating unit 68 is usually closed. As described above, the packing sheet S is held so that its upper-end opening is positioned below the lower end portion of the accumulating unit 68.

Accordingly, the prints P supplied from the conveying part 52 are temporarily accumulated in the accumulating unit 68, thereby bundling the prints P.

When it has been found that all prints P (including an order print) corresponding to one order have been accumulated in the accumulating unit 68 based on, for instance, the sort information, a result of counting of the number of prints, or discharge of the order print to the accumulating unit 68, the packer 34 opens the stopper 64, thereby dropping the accumulated and bundled prints P toward the opening of the packing sheet S and discharging the bundled print P from the accumulating unit 68. Then, the packer 34 closes the stopper 64 before the next print P is discharged to the accumulating unit 68.

As a result, the bundled prints P corresponding to one order in the accumulating unit 68 are dropped and packed in the packing sheet S opened by the opening means 62.

After the bundled prints P corresponding to one order has been packed in the packing sheet S, the opening means 62 releases the packing sheet S. When doing so, the opening means 62 further stops a fan as necessary. Next, a carrier roller pair 76 conveys and feeds the packing sheet S downward to a position at which the upper end portion of the packing sheet S reaches the sealing/cutting unit 66.

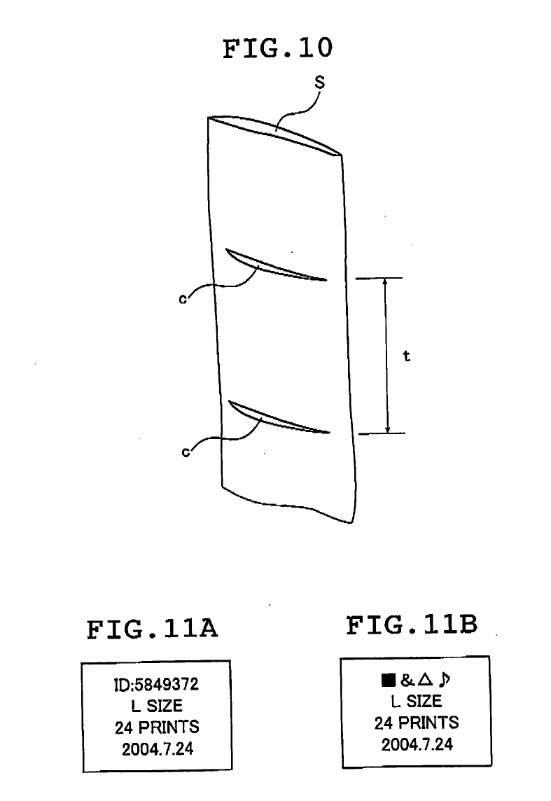

The sealing/cutting unit 66 fuses and closes the upper portion of the packing sheet S through heating by a heater or the like, thereby producing the print pack 80. When doing so, the sealing/cutting unit 66 further cuts each unnecessary portion as necessary. When the unnecessary potion cutting is not required, there occurs no problem even if the sealing/cutting unit 66 does not have a heat-cutting function, that is, only has a heat-sealing function. It should be noted that in the above description, the packing sheet S is the separated square-tube-shaped transparent bag matter. However, a tubular transparent long sheet shown in FIG. 10 may be used instead. The tubular transparent long sheet is obtained by placing two sheets on each other, bonding their end portions together, and forming slits for insertion of bundled prints P in a direction orthogonal to a lengthwise direction. The tubular transparent long sheet will be described in detail later.

The print pack 80 containing the bundled prints P is conveyed by the carrier roller pairs 76 and 78, and is received by the product receiving unit 70 through a guide 82.

As is apparent from the above description, in the production system 10 in the illustrated example, at the printer 16, prints corresponding to ordinary finishing orders are outputted to the sorter 36 like in the case of ordinary photographic prints and prints corresponding to urgent finishing orders are outputted to the packer 34 that produces print packs 80 by bundling and packing the prints.

Accordingly, it becomes possible for an operator to immediately know that prints in the print packs 80 discharged to the product receiving unit 70 of the packer 34 have been produced in response to urgent finishing orders and need to be dealt with (handled) urgently. Therefore, it becomes possible for the operator to swiftly extract the urgent finishing orders from among many outputted orders and deliver the prints (print packs) to customers in exchange for reception slips or the like. In a like manner, in the case of a system in which customers find their ordered prints from among prints put on a shelf and make payments at a checkout counter or the like, it becomes possible for the operator to swiftly extract the urgent finishing orders from among many outputted orders and immediately put them on the shelf.

As a result, according to the present invention described above, it becomes possible to realize a service, such as an urgent finishing service, in which ordered prints are provided to customers on the spot (or at a nearby delivery counter or shelf) with slight waiting time after order reception by the receiver 12.

As described above, in the production system 10 in the illustrated example, as a preferable form, each receiver 12 gives identification information for identification of itself to order information.

Accordingly, in the case of outputting prints (print pack 80) produced in response to the urgent finishing order, it is preferable to make it possible to identify the receiver 12 (12a, 12b, or 12c) that has received the order. This construction enables swifter print handling. In addition, when print packs are put on a shelf or the like, by separating the prints packs depending upon receivers, finding and extraction of the print packs by customers or the operator are further facilitated.

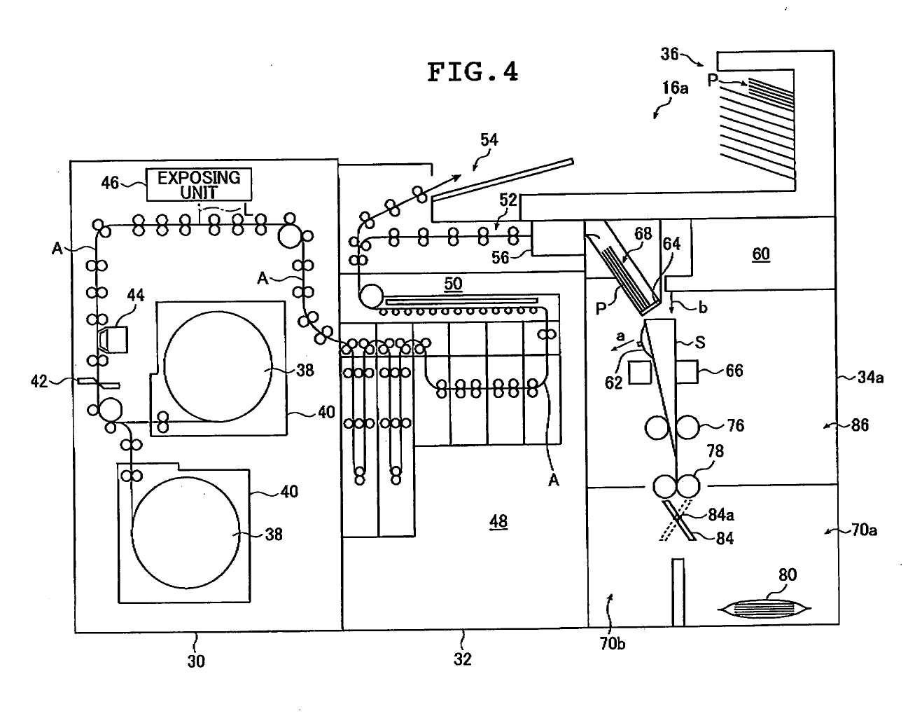

When prints corresponding to ordinary finishing orders are outputted to the sorter 36 and prints corresponding to urgent finishing orders are outputted to the packer 34 like in the case of the printer 16 shown in FIG. 3 of the production system 10 in the illustrated example, it is also possible to use a printer 16a shown in FIG. 4 instead. In the printer 16a, a product (print pack 80) receiving unit of a packer 34a is divided into a first receiving unit 70a and a second receiving unit 70b, and a flapper 84, which rotates about an axis 84a between a position indicated with a solid line and a position indicated with a dotted line to change a conveying path and switch a print pack discharge designation, is provided in place of the guide 82. In this case, the flapper 84 is switched depending upon the receivers 12 using the identification information of the receivers 12, thereby changing the receiving unit for outputted print pack 80.

The printer 16a shown in FIG. 4 operates in accordance with the identification information. More specifically, for instance, prints corresponding to urgent finishing orders received by the receiver 12a are outputted to the first product receiving unit 70a by setting the flapper 84 at the solid-line position and prints corresponding to urgent finishing orders received by other receivers (that is, the receiver 12b and the receiver 12c) are outputted to the second product receiving unit 70b by setting the flapper 84 at the dotted-line position, thereby making it possible to identify the receiver 12 that has received the urgent finishing orders.

It should be noted that in the illustrated example, only two product receiving units are provided and prints corresponding to urgent finishing orders received by the receiver 12b and the receiver 12c are received by the same product receiving unit 70b. But the present invention is not limited to this. For instance, the product receiving unit may be divided into three product receiving units and the flapper 84 may be set so as to be capable of coping with the three receiving units. In this case, print packs 80 corresponding to urgent finishing orders received by the receiver 12a, print packs 80 corresponding to urgent finishing orders received by the receiver 12b, and print packs 80 corresponding to urgent finishing orders received by the receiver 12c are respectively outputted to the three product receiving units.

In each of the examples shown in FIGS. 3 and 4, prints corresponding to ordinary finishing orders are outputted to the sorter 36, and prints corresponding to urgent finishing orders are outputted to the packer 34 or 34a to be then packed and outputted as print packs 80, thereby making it possible to identify the prints that have been outputted in response to the urgent,finishing orders at the output part.

Also, when the printer 16a shown in FIG. 4 is an apparatus that packs prints corresponding to ordinary finishing orders as well as prints corresponding to urgent finishing orders and outputs them as print packs 80, a method is also suitable with which the print packs 80 produced in response to the urgent finishing orders are outputted to the first receiving unit 70a and the print packs 80 produced in response to the ordinary finishing orders are outputted to the second receiving unit 70b, thereby making it possible to identify the prints that have been outputted to the output part in response to the urgent finishing orders.

Here, the present invention is not limited to the above description. It is possible to use various other methods as means for making it possible to identify prints corresponding to urgent finishing orders at the print output part. Note that it is of course possible to use multiple methods in combination as necessary.

For instance, in the case of a printer that includes neither the packer 34 nor the packer 34a and only includes the sorter 36 and the large size print discharging part 54, it is possible to use a method with which prints corresponding to ordinary finishing orders are outputted to the sorter 36 like in the examples described above and prints corresponding to urgent finishing orders are discharged to the large size print discharging part 54.

In this case, it becomes possible to immediately identify that prints discharged to the large size print discharging part 54 correspond to urgent finishing orders, so swift handling becomes possible.

Alternatively, means for enabling swift identification of prints corresponding to urgent finishing orders using the sorter 36 is also suitable.

For instance, when the sorter 36 includes 25 bins (output trays for 25 orders), prints corresponding to urgent finishing orders are discharged to upper six bins serving as the dedicated bins, and prints corresponding to ordinary finishing orders are discharged to lower 19 bins serving as the dedicated bins, thereby making it possible to identify that prints outputted to the upper 6 bins correspond to orders designating the urgent finishing. In this case, it is more preferable to allocate, for instance, the first bin and the second bin from the top to prints corresponding to urgent finishing orders received by the receiver 12a, the third bin and the fourth bin from the top to prints corresponding to urgent finishing orders received by the receiver 12b, and the fifth bin and the sixth bin from the top to prints corresponding to urgent finishing orders received by the receiver 12c, to thereby make it possible to identify the receivers 12 that have received the urgent finishing orders with ease.

Also, the means for making it possible to identify the prints corresponding to urgent finishing orders at the print output part is not limited to the methods with which the product receiving unit for outputting prints is changed in accordance with whether the prints correspond to urgent finishing orders or ordinary finishing orders, and various other methods are also usable.

For instance, it is possible to use a method with which an extra print showing that the prints correspond to the urgent finishing order is produced to be placed on the top of the prints for each urgent finishing order, thereby making it possible to immediately identify that the prints correspond to the urgent finishing order at the output part. Here, it is more preferable that receiver identification information be further recorded on the extra prints, thereby making it possible to identify the receivers 12 that have received the urgent finishing orders with ease. It is sufficient that images (image data) of the extra prints are formed at the DIC 14 and the extra prints are outputted at the printer 16 or 16a like in the case of the order print described above, for instance.

The size of the extra prints is not specifically limited but it is preferable that the extra print size be set somewhat larger than the size of prints, thereby enabling reliable detection of the extra prints. In addition, it is also possible to suitably use tags instead of the extra prints.

Aside from the methods described above, a method is also suitably usable with which on back surfaces of prints corresponding to urgent finishing orders, a notification that the prints correspond to urgent finishing orders is recorded by the back printer 44 as back prints (back printing). In this case, it is more preferable that receiver identification information be further recorded.

Alternatively, in the case of a system in which index prints are produced, it is also possible to suitably use a method with which in free spaces of index prints for prints corresponding to urgent finishing orders, a notification that the prints correspond to urgent finishing orders is recorded. In this case, it is more preferable that receiver identification information be further recorded in the index print free spaces.

When the printer 16 is an apparatus for packing prints corresponding to ordinary finishing orders as well as prints corresponding to urgent finishing orders and outputting them as print packs 80, it is also possible to suitably use a method with which different print pack (the packing sheet S) is used to pack the prints depending on whether the prints correspond to the urgent finishing order or to the ordinary finishing order.

For instance, it is possible to use a method with which a print pack different in color, design, or the like is produced depending on whether the prints correspond to the urgent finishing order or to the ordinary finishing order. In addition, it is also possible to use a method with which the prints corresponding to urgent finishing orders are packed using packing sheets S having a notification to that effect recorded thereon. Here, it is more preferable that the colors, designs, records, or the like of the packing sheets allow to identify the receivers 12 that have received the print orders.

In the examples described above, it is possible to identify the receivers 12 that have received the orders only in the case of the urgent finishing orders, but the present invention is not limited to this. For instance, completely the same method may be used also in the case of ordinary finishing orders to identify the receivers 12 that have received the orders.

In addition, even in a production system in which identification of prints corresponding to urgent finishing orders based on output positions or extra prints is not performed, or even in a production system that performs only the ordinary finishing, it is made possible to identify the receivers 12 that have received print orders in completely the same manner.

Next, the print order receiver according to a third mode of the present invention will be described with reference to FIGS. 1, 2, and 5 to 7C.

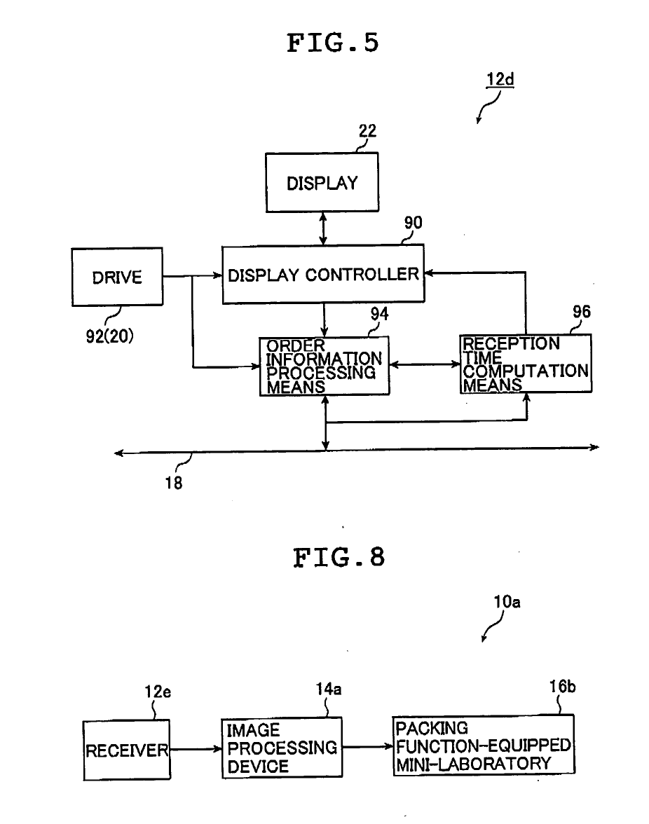

The print order receiver according to the third mode of the present invention is applicable to the print production system 10 shown in FIG. 1, has the external appearance shown in FIG. 2, and has a construction shown in FIG. 5 as at least a part thereof. Needless to say, however, the present invention is not limited to this.

It should be noted that in the following description, the print order receiver according to the present mode will be referred to as a receiver 12d and the explanation will be made by assuming that the three receivers 12 (12a, 12b, 12c) used in the production system 10 shown in FIG. 1 are each the receiver 12d according to the present invention, but the present invention is not limited to this.

That is, when the production system 10 includes a spooler such as the DIC 14 for temporarily holding images, it is sufficient that at least one of the three receivers 12a, 12b, and 12c is the receiver 12d according to the present mode. In this case, the rest of the receivers do not need to be the receiver according to the present mode. That is, in this case, the production system 10 which includes the receiver 12d according to the present mode may also include at least one print order receiver that is not the receiver 12d according to the present mode.

The receiver 12d according to the present mode has basically the same construction and function as the receivers 12 used in the production system 10 according to the first and second modes of the present invention shown in FIGS. 1 and 2 except for a part of the construction shown in FIG. 5, so each same construction element is given the same reference numeral and the detailed description thereof will be omitted.

FIG. 5 is a block diagram conceptually showing a construction of a part of an order information processing system in the receiver 12d according to the present mode.

As shown in FIGS. 2 and 5, the receiver 12d includes the loading unit 20 for loading a storage medium (media) thereinto, the display 22, the reception slip output unit 24, the display controller 90, a (media) drive 92 for reading/recording image data from/into the storage medium loaded into the loading unit 20, order information processing means 94, reception time computing means 96, and a printer (not shown) for creating print claim checks.

The display controller 90 controls image display and input display on the display 22 and sends various kinds of information inputted through the display 22 (touch panel) to predetermined sites such as the order information processing means 94.

In response to an order, the order information processing means 94 generates an order ID (identification information) for the order, processes an order instruction inputted through the display 22, relates order information, which shows the order ID, images whose prints are to be produced, the number of the prints, the sizes of the prints, whether the urgent finishing or the ordinary finishing has been designated, a print reception time (time at which a customer becomes capable of receiving the prints), and the like, and images (image data) corresponding to the order to each other, and outputs them to the DIC 14 through the network 18. Also, the order information processing means 94 sends the order information to the reception time computing means 96.

The reception time computing means 96 computes a print reception time from the order information supplied from the order information processing means 94, the images and the print sizes stored in the DIC 14, the status of the printer 16, and the like. Then, the reception time computing means 96 sends the computed reception time to predetermined sites such as the display controller 90, the order information processing means 94, and the reception slip producing printer.

These points will be described in detail later.

It should be noted that in the production system 10 to which the receiver 12d according to the third mode of the present invention is applied, the DIC 14 supplies output images (image data) to the printer 16 so that images corresponding to a order, whose computed reception time is nearest to the current time, are outputted first. Therefore, as described above, in the case of an order designating the urgent finishing or the like, output images (image data) are supplied to the printer 16 prior to images corresponding to other orders placed before the order (while getting ahead of the other orders), as necessary.

In the production system 10 described above, as a preferable form, the printer 16 to be described later automatically packs prints in units of orders and outputs the prints as print packs.

In this case, as a preferable form, the DIC 14 produces, for each order, an image (order print image) of an order print, on which an order ID, a print fee, the numbers of prints, and the like are recorded, and supplies it to the printer 16 together with images for each order.

The printer 16 is the printer of the above described digital mini-laboratory that outputs (finished) prints by imagewisely exposing printing paper (photosensitive material) with recording light, such as laser light, modulated in accordance with output images (output image data) supplied from the DIC 14, to form latent images, performing predetermined development processing on the exposed photosensitive material, and drying the developed photosensitive material.

It should be noted that the printer 16 in the illustrated example is different from an ordinary printer that sorts prints in units of orders to output prints to a sorter. That is, as described above, as a preferable form, the printer 16 puts prints in transparent bags or the like in units of orders, seals the bags containing the prints, and outputs the sealed bags as print packs. Note that it is sufficient that the print packs are produced using a known sheet-shaped matter layered product packing technique.

Hereinafter, the print order receiver according to the third mode of the present invention will be described in more detail by explaining an operation of the receiver 12d in the production system 10 with reference to a flowchart in FIG. 6.

As a preferable form, the receiver 12d displays a provisional print reception time at the moment under a state of waiting a print order input (step S200).

More specifically, the reception time computing means 96 acquires image information (showing the numbers of pixels of images, the sizes of prints, the numbers of the prints, the contents of image processing, and the like) stored in the DIC 14 and the status (operating status, accumulated print information (=information concerning images waiting to be processed), and the like) of the printer 16 by browsing the DIC 14 and the printer 16 through the network 18, and calculates the provisional print reception time (provisional time at which prints are finished and print provision to a customer becomes possible) in consideration of the processing capability (such as the numbers of prints in respective print sizes that are outputtable per unit time) of the printer 16 as well as time taken by inspection, checking, packing, and the like.

Then, the reception time computing means 96 sends information showing the computed reception time to the display controller 90. The display controller 90 displays the provisional print reception time on the display 22.

It should be noted that as described above, the receiver 12d outputs images and order information of each received order to the DIC 14. Accordingly, it becomes possible to know the print order reception statuses of other receivers 12 from the images, print sizes, and the like stored in the DIC 14.

Also, the receiver 12d may directly browse the statuses of other receivers 12d.

Here, at the receiver 12d (in the production system 10) in the illustrated example, as a preferable form, it is possible to make a selection between the ordinary finishing, in which print production processing is basically performed in the order in which orders were received, and the urgent finishing in which orders are preferentially processed for print production while getting ahead of other orders placed before the orders within a possible range. Also, in the system 10, a print fee for the urgent finishing is set higher than a print fee for the ordinary finishing.

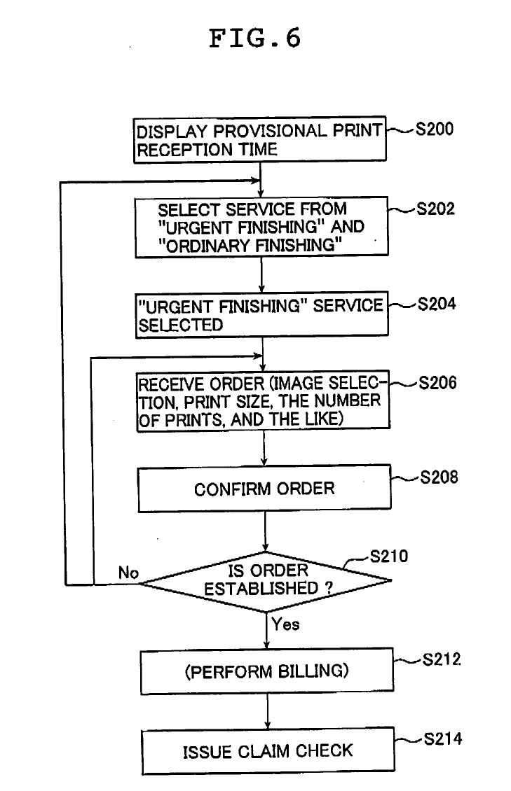

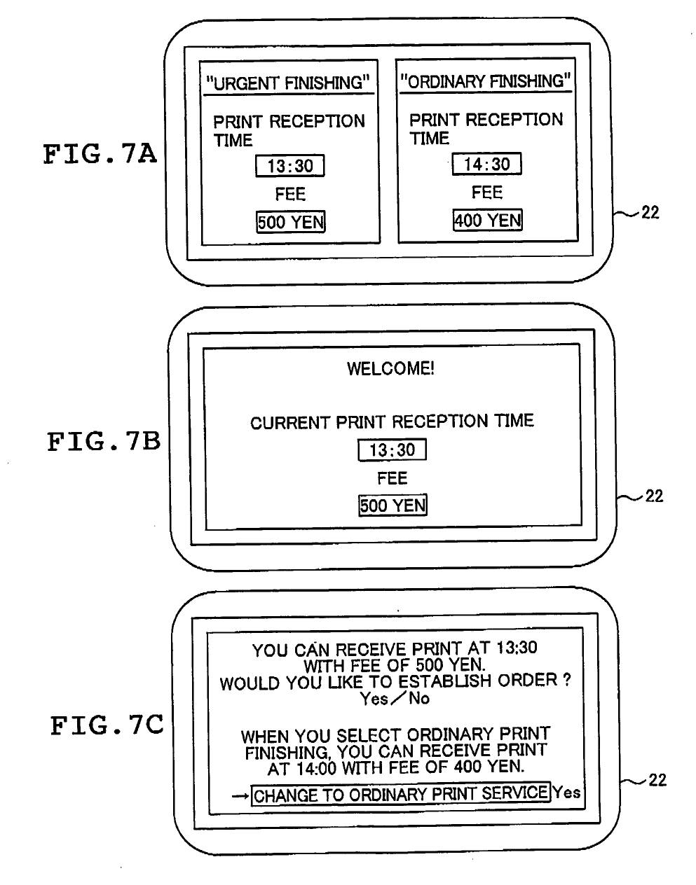

Therefore, for instance, as shown in FIG. 7A, the receiver 12d displays a provisional reception time and fee in the case of the urgent finishing and a provisional reception time and fee in the case of the ordinary finishing on the display 22. Note that the fees and reception times are calculated for a predetermined number of prints (30 prints, for instance) in the most general print size, for instance. Alternatively, a message that “You can receive prints at around 13:30 in the case of 10 L-size prints and at around 13:40 in the case of 20 L-size prints” or the like may be displayed.

It should be noted that when the system 10 is not so busy and the reception time in the case of the ordinary finishing and the reception time in the case of the urgent finishing are approximately equal to each other, for instance, even when the urgent finishing has been designated, the fee may be computed by regarding that not as the urgent finishing but as the ordinary finishing has been designated.

Also, in the case of a print production system in which the urgent finishing is not performed, for instance, the provisional reception time at the moment is calculated in the same manner as in the case of the ordinary finishing and is displayed together with a fee, as shown in FIG. 7B.

At the receiver 12d in the illustrated example, when a storage medium (storage media) has been loaded into the loading unit 20, this is regarded as an instruction to start print order reception, and the drive 92 reads images (image data) from the loaded storage medium.

In parallel with the operation described above, the display controller 90 displays a service selection screen, through which a selection between the urgent finishing and the ordinary finishing is made, on the display 22 (service selection) (step S202).

In this example, it is assumed that the urgent finishing has been selected in the service selection (step S204).

After the service selection, the display controller 90 displays an order screen on the display 22. It is sufficient that the order screen and an order input method of the receiver 12d are basically the same as those of an ordinary print order receiver. As described above, the display 22 is set as a touch panel, so, for instance, images read by the drive 92 from the recording medium are displayed on the display, buttons for input of the sizes of prints to be produced and the numbers of the prints, buttons for designation of various kinds of special processing such as soft focusing and sepia finishing, and the like are also displayed on the display, images are selected by touching the displayed images, and the sizes of the prints, the numbers of the prints, and the like are inputted using the various buttons (step S206).

It should be noted that in the illustrated example, the order screen and the order method used by the receiver 12d in the case of the urgent finishing and those in the case of the ordinary finishing are the same.

However, the present invention is not limited to this and the order screen and the order method in the case of the urgent finishing and those in the case of the ordinary finishing may be set different from each other. For instance, in the case of the urgent finishing, there is a possibility that it is more convenient for a customer that an order can be placed speedily. Therefore, in the case of the urgent finishing, an order screen and an order method may be used with which when the urgent finishing has been selected, a print is automatically produced for each of the all images recorded in a storage medium with a preset size. Alternatively, an order screen and an order method may be used with which after a customer has selected the number of prints to be produced and the size of the prints, the selected number of prints with the selected print size are automatically produced for each of the all images recorded in a storage medium. Still alternatively, a construction may be used in which a selection between the former order screen and order method and the latter order screen and order method is possible. Also, a construction may be used in which in the case of the urgent finishing, it is possible to make a selection between an order method, with which an order for production of prints from all images is automatically placed, and an order method with which an order for production of prints only from selected images is placed. Further, a construction may be used in which even in the case of the ordinary finishing, a selection between the order methods described above is possible.

The print order inputted through the display 22 is sent from the display controller 90 to the order information processing means 94. The order information processing means 94 processes order information, which shows the images whose prints are to be produced, the numbers of the prints, the sizes of the prints, and the like, and sends the order information to the reception time computing means 96. Here, even during this operation, the reception time computing means 96 browses the DIC 14 and the printer 16 through the network 18 and acquires information.

When the input of the print order by the customer is finished, the reception time computing means 96 acquires order information, which shows the numbers of prints to be produced in response to the order, the sizes of the prints, the contents of image processing, and the like, information about images stored in the DIC 14 (same as before), and the processing status of the printer 16 (same as before) and calculates a print reception time (nearest time at which the prints are finished and print provision to the customer becomes possible with reliability) in consideration of the processing capability of the printer 16 (same as before) and time taken by inspection, checking, packing, and the like.

The print time varies depending on the numbers of prints to be made, the sizes of the prints, and images (numbers of pixels). Therefore, before the order input is finished, only a provisional print reception time can be calculated and when the order input is completed, it becomes possible to calculate a correct print reception time.

Here, in this example, it is assumed that the order designates the urgent finishing, so the reception time computing means 96 calculates the reception time in consideration of the processing order so that the order is processed while getting ahead of other orders placed before the order and prints corresponding to the order are provided as soon as possible within a range in which the reception times (reception times informed to customers at the time of order establishment) of the other orders are not influenced.

Also, in the case of the ordinary finishing, the reception time computing means 96 calculates the reception time in the order in which orders were placed.

Then, the reception time computing means 96 sends information showing the computed reception time to the display controller 90.

The display controller 90 displays a print order confirmation screen, which at least contains information showing the reception time and the print fee, on the display 22 to thereby ask the customer to established the order (step S208). Here, a slight margin may be added to the reception time computed by the reception time computing means 96 and a resultant reception time may be used.

FIG. 7C shows an example of the confirmation screen. In the illustrated example, as a preferable form, in addition to the reception time and the fee in the case of the urgent finishing, a reception time in the case of the ordinary finishing is also calculated by the reception time computing means 96 and the reception time and a fee in the case of the ordinary finishing are also displayed in the confirmation screen. Also, it is possible for the customer to make a change from the urgent finishing to the ordinary finishing through the screen. Here, it is more preferable that it be possible to change the fee in accordance with the reception time.

It should be noted that even after the confirmation screen has been displayed, the reception time computing means 96 browses the DIC 14 and the printer 16 at all times until order establishment has been inputted.

When a change of a status of the system 10, such as transmission of a new order from another receiver 12d to the DIC 14 or the like, which influences the reception time has been detected as a result of the browsing, the reception time computing means 96 computes a new reception time and sends it to the display controller 90, which then updates the reception time displayed on the display 22.

When the order establishment has been inputted (Yes), at the receiver 12d, the order information processing means 94 relates order information which shows an order ID, images whose prints are to be produced, the numbers of the prints, the sizes of the prints, whether the urgent finishing or the ordinary finishing has been designated, the print reception time, and the like, and images corresponding to the order to each other, and outputs them through the network 18 (step S210).

Next, the receiver 12d carries out billing with a credit card or the like as necessary (step S212). Then, the receiver 12d issues a print claim check (receipt) on which the order ID or the like has been recorded (step S214). Note that it is preferable that the fee and the reception time computed when the order has been established be recorded on the claim check, and it is more preferable that in the case of the urgent finishing, a notification that the urgent finishing has been designated be recorded thereon.

It should be noted that when the order establishment has been canceled through the confirmation screen (No), the receiver 12d returns to the service selection screen and asks the customer to make the service selection again or returns to the order screen and asks the customer to make the order input again (step S210).

The screen, to which the receiver 12d returns, may be uniquely determined or may be set selectable by the customer.

After having received the order information and the images from the receiver 12d in the manner described above, the DIC 14 performs necessary image processing on the supplied images, and preferably produces an order print image to send the images to the printer 16 in an order corresponding to the reception time.

The printer 16 produces (finished photographic) prints by imagewisely exposing printing paper with recording light modulated in accordance with the images to form latent images, performing predetermined development processing on the exposed printing paper, and drying the developed printing paper. Then, the printer 16 packs the prints in units of orders and outputs them as a print pack.

As is apparent from the above description, with the receiver 12d according to the third mode of the present invention, it becomes possible for a customer to know a print reception time when the customer has placed a print order, so it becomes possible for the customer to determine in accordance with the reception time whether to wait for prints to be finished and delivered on the spot or to revisit a store to receive the prints, which eliminates a necessity for the customer to unnecessarily revisit the store.

Also, with the receiver 12d, it becomes possible for the customer to make a selection between the ordinary finishing and the urgent finishing. Here, in ordinary cases, a fee for the urgent finishing is set higher than that for the ordinary finishing, so it is made possible for the customer to make the service selection in consideration of the reception time and the fee, thereby further improving customer convenience.

In the example described above, at the receiver 12d, after service selection between the urgent finishing and the ordinary finishing has been made, order input is performed but the present invention is not limited to this. For instance, a construction is also possible in which after the order input has been performed, the service selection is made and order confirmation screen displaying, order establishment, and order processing are performed. Alternatively, a construction may be used in which after the order input has been performed, the order confirmation screen, which presents a fee and reception time corresponding to the urgent finishing and a fee and reception time corresponding to the ordinary finishing, is displayed, the service selection is made using the confirmation screen, and then the order establishment is performed.

Regardless of which one of the forms described above is adopted, it is preferable that the reception time computing means 96 browse the DIC 14 and the printer 16 at all times and update the provisional reception time and the reception time calculated corresponding to the order as necessary.

Also, in the above description, the third mode of the present invention has been described by taking, as a representative example, a case where the dedicated (print order) receiver 12d is used but the present invention is not limited to this and, instead of using such a completely dedicated device, a PC installed in a laboratory or the like may be caused to function as the print order receiver according to the present invention by installing dedicated order receiving software onto the PC.

Further, the third mode of the present invention is also applicable to a so-called Internet order in which a print production order is placed using a personal computer (PC) at home or the like through a computer communication network such as the Internet. In this case, the PC of a print orderer at home or the like functions as the print order receiver according to the present mode.

Next, the image forming apparatus according to the fourth mode of the present invention and the image forming method according to the fifth mode of the present invention will be described with reference to FIGS. 8 to 11B.

FIG. 8 is a block diagram conceptually showing an embodiment of a print production system that uses the image forming apparatus according to the fourth mode of the present invention that implements the image forming method according to the fifth mode of the present invention.

A print production system (production system) 10a shown in FIG. 8 produces (finished photographic) prints corresponding to each customer order (order information) from images (image data) photographed with a digital camera, a cellular phone, or the like and produces a print pack. Therefore, as shown in FIG. 8, the production system 10a includes a print order receiver (receiver) 12e, an image processing device 14a, and a packing function-equipped mini-laboratory (hereinafter simply referred to as the “mini-laboratory”) 16b, for instance. These may be connected to each other through a dedicated line or may be connected to each other through a known network.

In the production system 10a shown in FIG. 8, as a preferable form, the image forming apparatus according to the present mode includes the image processing device 14a and the mini-laboratory 16b. These may be constructed integrally with each other or may be constructed separately from each other.

Also, the image forming apparatus according to the present mode may include multiple image processing devices 14a and/or multiple mini-laboratories 16b. Further, one image forming apparatus may be compatible with multiple receivers 12e. Still further, one receiver 12e may be compatible with multiple image forming apparatuses. Note that the image forming apparatus according to the present mode which includes the image processing device 14a and the mini-laboratory 16b, is not limited to the application to the production system 10a shown in FIG. 8, and may be applied to the production system 10 shown in FIG. 1 by replacing the DIC 14 and the printer 16 with the image processing device 14a and the mini-laboratory 16b in FIG. 1. Accordingly, in the following description, the detailed explanation of each construction element having a common function will be omitted and each different portion will be mainly described in detail.

Like the receiver 12 shown in FIG. 1, the receiver 12e is a known print order receiver, which is installed in a laboratory, a commercial facility, or the like and receives orders for production of prints from images (image data) photographed with an imaging device such as a digital camera and a cellular phone having a photographing function, and includes output means for printing claim checks.

That is, when a storage medium is loaded at a predetermined position by a customer (print production orderer) or when an imaging device, such as a digital camera or a cellular phone, is connected by the customer, the receiver 12e reads images (image data) stored in the loaded medium or the connected device, displays the read images on a display, asks the customer to input information (order data) necessary to place a print order, and asks the customer to select an image whose print is to be placed on the top of a print pack. On receiving the order from the customer, the receiver 12e relates the images corresponding to the order and the order data to each other and supplies them to the image processing device 14a. As the receiver 12e applied to the present mode, it is possible to use any of the receivers 12, 12a to 12c, and 12d applied to the first to third modes of the present invention.

It should be noted that according to the present mode, it is further required to rearrange image data of the images corresponding to the order so that a print of the image selected at the receiver 12e is placed on the top of a print pack. This image data rearrangement may be performed at the receiver 12e or may be performed at the image processing device 14a to be described later.

It should be noted that it is sufficient that the image data rearrangement is performed so that the front surface (image recording surface) of the print of the selected image can be seen from the outside of the print pack to be described later. Therefore, for instance, when prints are discharged from the mini-laboratory 16b with their back surfaces facing up, the rearrangement is performed so that the print of the selected image to be placed on the top of the print pack is discharged first. On the other hand, when the prints are discharged from the mini-laboratory 16b with their front surfaces facing up, the rearrangement is performed so that the print of the selected image is discharged last.

The order images and order data after the rearrangement are sent to the image processing device 14a. In addition, when the order has been received, the receiver 12e creates and outputs a claim check on which order contents, a reception number, a delivery date and time, and the like are written. Here, it is more preferable that the image placed on the top of the print pack be printed on the claim check.

It should be noted that as examples of the order data, in addition to information indispensable to print production such as images whose prints are to be produced, the sizes of the prints, the numbers of the prints, and a reception number (reception ID), it is possible to cite a reception date and time, a customer ID, the name of the customer, the contact information (telephone number or the like) of the customer, and the address of the customer.

Also, like the receiver 12 in the production system 10 shown in FIG. 1, the receiver 12e in the production system 10a is not limited to a dedicated receiver installed in a store or the like and may be a device that is applicable to a so-called Internet order in which a print production order is placed using a personal computer (PC) at home or the like through a computer communication network such as the Internet, an e-mail order from a cellular phone, or the like.

Further, the image forming apparatus according to the present mode is not limited to production of prints from images received at the receiver 12e and may be applied to production of prints from images (image data) obtained by reading a photographic film with a scanner (image reading apparatus).

The image processing device 14a is an device that receives the images (image data) corresponding to the order and the order data from the receiver 12e, generates print images (output image data) by performing image processing corresponding to the order data on the images (image data) supplied from the receiver 12e, and supplies the print images to the mini-laboratory 16b. Note that in the production system 10a, the image processing device 14a may receive the order images (image data) that are related to the order data in the receiver 12e and the image (image ID or image data) selected in the receiver 12e to be placed on the top of the print pack (in some cases, only a selection condition designated at the receiver 12e) from the receiver 12e for each order, and rearrange the image data of the images so that a print of the selected image or an image corresponding to the designated selection condition is placed on the top of the print pack. In this case, it does not matter whether the image processing device 14a first performs the image processing on the images (image data) of one order supplied from the receiver 12e and then performs the image (image data) rearrangement of the one order, or first performs the image rearrangement of one order and then performs the image processing for the one order. Here, the DIC 14 used in the production system 10 shown in FIG. 1 may be used as the image processing device 14a.

It should be noted that in the production system 10a, not the receiver 12e but the image processing device 14a may acquire the images (image data) and the order data. Even in this case, after the data acquisition, the same processing as above may be performed.

Here, the image processing device 14a may perform image processing that is the same as the image processing performed by the DIC 14 described above.

Also, it is preferable that after the last image (one of the order print image and the selected image to be placed on the top of the print pack) corresponding to one order has been supplied, the image processing device 14a output sort information indicative of the end of one order to the mini-laboratory 16b.

An image pre-selected by the receiver 12e is used as the print of the selected image placed on the top of the print pack, although this will be described in detail later.

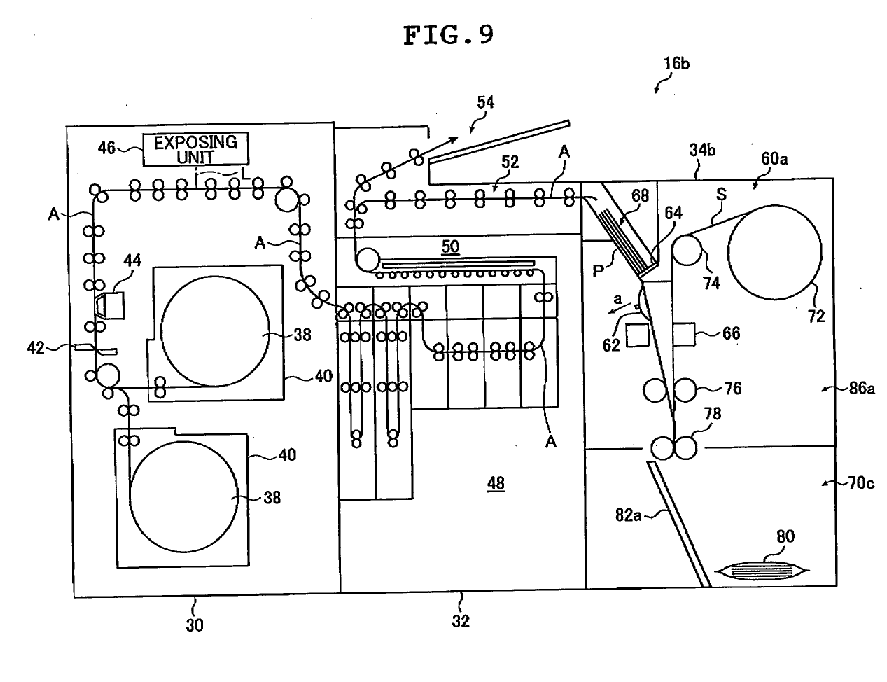

FIG. 9 is a diagrammatically illustrated cross-sectional view conceptually showing an embodiment of the packing function-equipped mini-laboratory 16b of the production system 10a in FIG. 8.

The packing function-equipped mini-laboratory (mini-laboratory) 16b shown in FIG. 9 has the same construction as the printer 16 shown in FIG. 3 except that the conveyance switching part 56 and the sorter 36 are omitted and the construction of the packer 34 is slightly changed, more specifically, a tubular transparent long sheet (see FIG. 10) is used as the packing sheet S and all outputted prints P are bundled in units of orders and are put in the packing sheet S to produce print packs. Therefore, each same construction element is given the same reference numeral and the detailed description thereof will be omitted.

The mini-laboratory 16b produces (finished photographic) prints by exposing a photosensitive material (printing paper) in accordance with the print images (image data) and the selected image (image data) to be placed on the top of a print pack supplied from the image processing device 14a to form latent images, performing predetermined wet development on the exposed photosensitive material, and drying the developed photosensitive material, and produces print packs by packing the prints (putting the prints in the packing sheet S) in units of orders.

In the example shown in FIG. 9, the mini-laboratory 16b includes the exposure part 30, the processor 32, and a packer 34b.

In the mini-laboratory 16b of the illustrated example, the photosensitive material A is pulled out of the magazines 40 to be cut into a print size by the cutter 42 and is supplied to a predetermined exposing position after recording of a back print by the back printer 44.

Images (order print images and an image to be placed on the top of the print pack) supplied from the image processing device 14a are supplied to the exposing unit 46. The photosensitive material A is two-dimensionally scan-exposed by the exposing unit 46 with the optical beam L modulated in accordance with the images, and latent images are recorded on the photosensitive material A. The photosensitive material A, on which the latent images have been recorded, is sequentially supplied to the processor 32.

The exposed photosensitive material A supplied to the processor 32 is first conveyed to respective processing vessels of the developing part 48 in which the photosensitive material A is subjected to development processing, beaching/fixing processing, and water washing processing in succession. Next, the photosensitive material A is dried by a heater or the like at the drying part 50 to obtain (finished photographic) prints P. Then, all prints P other than large-sized prints P that are directly discharged to the large size print discharging part 54 without being packed pass through the conveying part 52 and are discharged to the packer 34b (accumulating unit 68) in units of orders.

The packer 34b is for accumulating and packing prints in units of orders based on order data, and includes a packing unit 86a having a sheet supply unit 60a for supplying the packing sheet S, the opening means 62, the stopper 64, the sealing/cutting unit 66 and the accumulating unit 68, and a product receiving unit 70c.

As shown in FIG. 10, the packing sheet S is a tubular transparent long sheet obtained by placing two sheets on each other and bonding their end portions together, and has slits c formed in one surface side extending in a direction orthogonal to a longitudinal direction at intervals t corresponding to the length of each print pack 80. The packing sheet S, which is rolled up in a roll shape with its surface having the slits c being directed toward the accumulating unit 68, is loaded into the sheet supply unit 60a as a sheet roll 72 to be conveyed through a predetermined path by a guide roll 74 and the carrier roller pairs 76 and 78.

Also, the opening means 62 holds (for example, by suction) a portion just below the slit c of the packing sheet S and moves in a direction that opens the tube of the packing sheet S (a direction of an arrow a in FIG. 9), thereby opening the packing sheet S at the slit c. More preferably, wind is blown to the slit c from above by a fan, thereby inflating the packing sheet S.

In the illustrated example, a lower portion of the packing sheet S is guided by the carrier roller pair 76 under a state in which a lower end portion thereof has been sealed in a manner to be described later, and the packing sheet S is on standby under a state in which the sheet S is suspended from the guide roll 74 while being opened at the slit by the opening means 62.

The prints P conveyed through the conveying part 52 are supplied to the accumulating unit 68. The accumulating unit 68 has a downwardly inclined slope so that its lower end is directed toward an opening portion at the slit of the packing sheet S opened by the opening means 62, and the stopper 64 at the lower end portion of the accumulating unit 68 is usually closed. Accordingly, the prints P supplied from the conveying part 52 are temporarily accumulated in the accumulating unit 68 to be in a bundle of the prints P.

At this time, as described above, in the mini-laboratory 16b, the print of the image to be placed on the top of a print pack is discharged first in one order when the prints are discharged with their back surfaces facing up and is discharged last in one order when the prints are discharged with their front surfaces facing up.

The packer 34b operates in the same manner as the packer 34. That is, when it is found that all prints P (including an order print) corresponding to one order are accumulated in the accumulating unit 68, the packer 34b opens the stopper 64, thereby dropping the accumulated and bundled prints P toward the opening of the packing sheet S and discharging the prints P from the accumulating unit 68. Then, the packer 34b closes the stopper 64 before the next print P is discharged to the accumulating unit 68.

As a result, the bundle of the prints P for one order in the accumulating unit 68 is dropped and packed in the packing sheet S through the opening at the slit c formed by the opening means 62.

After the bundle of the prints P for one order has been packed in the packing sheet S, the opening means 62 releases the holding of the packing sheet S (the opening operation part 62 further stops a fan as necessary). Next, the sheet roll 72 and the carrier roller pair 76 are rotated to feed the packing sheet S to a position at which the slit c reaches the sealing/cutting unit 66.

The sealing/cutting unit 66 is fox fusing and cutting the packing sheet S through heating or the like, and includes a heater that has a minute convex portion extending in a widthwise direction in a center portion in a direction in which the packing sheet S is conveyed.

The feeding of the packing sheet S is stopped when the slit c has reached the convex portion of the heater of the sealing/cutting unit 66. Next, the sealing/cutting unit 66 (the heater) is pressed against the packing sheet S to seal (close) the packing sheet S in an upper portion and a lower portion of the slit c. Then, the packing sheet S is cut along the slit c at the convex portion.

As a result, the packing sheet S that will contain the next bundle of prints e is closed at the lower end thereof (lower end of the packing sheet S that continues from the sheet roll 72) and the packing sheet S containing the prints P for one order is closed at the upper end thereof and cut to obtain the print pack 80.

The print pack 80 containing the bundle of the prints P is conveyed by the carrier roller pairs 76 and 78 to be received by the product receiving unit 70c through a guide 82a.

Hereinafter, the image forming apparatus and the image forming method according to the present invention will be described in more detail by explaining an operation of the production system 10a and operations of the receiver 12e, the image processing device 14a, and the packing function-equipped mini-laboratory 16b constituting the production system 10a with reference to FIGS. 8 and 9.

As described above, at the receiver 12e, after having placed and established a print order, a customer selects an image to be placed on the top of a print pack.

As described above, the image selected by the customer from among images corresponding to one order is used as the image to be placed on the top of the print pack. When doing so, all of the images corresponding to the print order are displayed on display means, such as a display, of the receiver 12e and the customer is asked to select an image to be placed on the top from among the displayed images.

When the image to be placed on the top is selected by the customer from among the order images after the order establishment, the receiver 12e outputs a sample hard copy of a simplified selected image through printing on a claim check or outputs it through printing on a sheet separated from the claim check concurrently with output of the claim check.

After the output of the claim check, the receiver 12e relates the images and order data corresponding to the established one order to each other, rearranges the image data corresponding to the order so that a print of the selected image is placed on the top of the print pack, and sends the rearranged image data to the image processing device 14a.

The image processing device 14a processes the supplied images in accordance with the order data and sends the processed images to the mini-laboratory 16b as order print images. In addition, the image processing device 14a sends the selected image to be placed on the top of the print pack for one order to the mini-laboratory 16b at the end (or start) of the images corresponding to one order.

The mini-laboratory 16b obtains prints P by exposing the photosensitive material A in accordance with the supplied order print images and the selected image to be placed on the top of the print pack to record latent images at the exposure part 30, performing predetermined development processing, and drying the exposed photosensitive material A at the processor 32, and sends the prints P to the packer 34b. At the packer 34b, the prints P are bundled and packed in units of orders and are discharged to the product receiving unit 70c as the print pack 80 as described above.

In the print pack 80 containing the prints P, the print of the image selected by the customer at the receiver 12e is placed on the top. The customer finds his/her print pack 80 based on the image outputted by the receiver 12e at the time of the order placement, brings the found print pack 80 as well as a claim check to a checkout counter, and makes a payment at the counter.

As described above, the customer only need to find a print pack on top of which the image selected by the customer is placed, so the customer can find his/her print pack 80 with ease. Also, the customer can select the image to be placed on the top of the print pack by himself/herself, so customer privacy can be protected.

In this embodiment, as a method of selecting the image to be placed on the top of the print pack, the method described above (hereinafter referred to as the “pattern A”) is exemplified. In addition, four patterns B to E to be described below are also prepared as methods of selecting the image to be placed on the top of the print pack.

The pattern B is a method with which an image appropriately selected by the customer or the receiver 12e from an image library stored in the receiver 12e in advance is used. More specifically, multiple images are stored in the receiver 12e in advance and at the time of a selection of the image to be placed on the top of the print pack, the stored images are displayed on display means, such as a display, of the receiver 12e and the customer selects one of the displayed images. Note that with this method, at the time of image selection for each order, images already selected for other orders are excluded from choices in advance, for instance. In this manner, a situation, in which the same image is selected for multiple orders and is placed on the top in multiple print packs, is prevented.

As the pattern C, it is possible to cite a method with which an image whose human face area is smallest is used among images which contain human subjects, out of images corresponding to one order placed.

In this case, the selection of the image to be placed on the top of the print pack is not made at the receiver 12e and the images corresponding to the one order placed are supplied to the image processing device 14a. At the image processing device 14a, image analysis is conducted on each image corresponding to the one order placed and an image whose human subject area is smallest, out of the images containing human subjects, is selected as the image to be placed on the top of the print pack. A method of the image analysis is not specifically limited and it is sufficient that a known method is used. Also, in this embodiment, the image analysis is conducted at the image processing device 14a but the present invention is not limited to this and the image analysis may be performed at externally connected image analyzing means or the like.

As the pattern D, it is possible to cite a method with which an image which contains no human subject among images corresponding to one order placed, is used.

In this case, the selection of the image to be placed on the top of the print pack is not made at the receiver 12e and the images corresponding to the one order placed are supplied to the image processing device 14a. At the image processing device 14a, image analysis is conducted on each image corresponding to the one order placed and an image which contains no human subject is selected as the image to be placed on the top of the print pack. As in the case of the pattern C, a method of the image analysis is not specifically limited and it is sufficient that a known method is used. Also, in this embodiment, the image analysis is conducted at the image processing device 14a but the present invention is not limited to this and the image analysis may be performed at externally connected image analyzing means or the like as in the pattern C.

As the pattern E, it is possible to use a method with which an image obtained by blurring an index image is used. With this method, the selection of the image to be placed on the top of the print pack is not made at the receiver 12e and the images corresponding to the one order placed are supplied to the image processing device 14a. At the image processing device 14a, a blurred index image that cannot be seen clearly is obtained by performing image processing on images that are the same as those used for an ordinary index print image for the images corresponding to the one order placed and is set as the image to be placed on the top of the print pack, thereby enabling the customer to distinguish prints corresponding to his/her order while protecting customer privacy.

It should be noted that in this embodiment, the five patterns described above are prepared for the selection of the image to be placed on the top of the print pack. However, the present invention is not limited to this and the number of the prepared patterns may be increased to six or more or decreased to four or less.

Also, the patterns A to E described above may be combined with a method with which images are made unclear through processing of the images. The image processing is not specifically limited and it is possible to use various image processing such as blurring and pictorial conversion. In addition, as a method of the image processing, it is sufficient that a known image processing method is used.

With the patterns A, C, and D, an order print is used as the print of the image selected to be placed on the top of the print pack, for instance. Alternatively, a print that is different from the order print may be outputted for the selected image to be used. When the order print is used, it is unnecessary to additionally output a print for the placement on the top, which reduces consumption of the photosensitive material. In this case, a timing of rearrangement is not specifically limited but it is preferable that after the image to be placed on the top of the print pack is determined, the image data be rearranged in the receiver 12e or the image processing device 14a and be supplied to the mini-laboratory 16b, which then produces prints in accordance with the rearranged image data.

When an order print is used as the print of the image selected to be placed on the top of the print pack, a barcode, a fee, order information, and the like are written on a sticker and the sticker is attached to a bag, for instance.

Also, when it is impossible to use an order print as the print of the image selected to be placed on the top of the print pack like in the case of the patterns B and E, a print ID, order information, a fee, a barcode, and the like may be written on a sticker print, and the sticker print may be attached to the print pack or may be printed in a free space of the print of the image selected to be placed on the top of the print pack.

Alternatively, it is also possible to write the order information, fee, barcode, and the like on the back surface of a bottom print in the print pack. In this case, the customer can confirm whether prints correspond to his/her order based on the image placed on the top, and staff member in a store can use the order information, a fee, a barcode, and the like written on the back surface of the bottom print.

It should be noted that the reproduced information, such as the order data, is not limited to the examples described above. In addition thereto, it is possible to write various kinds of information possessed by the order data, an advertisement, and the like. More specifically, it is possible to write various kinds of information corresponding to the order data, such as a reception number, a reception date and time, a customer ID, the telephone number (TEL) of the customer, the address and name of the customer, the file names of images whose prints have been produced, the numbers of the prints, a print fee, and a barcode of the print fee or the like, as well as the name of a print shop, an advertisement for the print shop, an index image of the prints, a discount coupon, and the like.

Also, instead of an image, a combination of symbols and marks may be recorded on the print placed on the top of the print pack.

For instance, FIG. 11A shows an example of the print placed on the top in the case where the order print checking is performed based on an order ID composed of a 7-digits number. FIG. 11B shows an example of the print placed on the top in the case where the order print checking is performed based on symbols and marks. When symbols are used like in the example shown in FIG. 11B, checking can be made at a glance, so an intended print pack can be found easily.

As is apparent from the above description, according to the present invention, when prints are packed using a packer or the like, a print of an image selected as appropriate is placed on the top of accumulated prints, thereby enabling a customer to find his/her prints with ease while protecting customer privacy.

The print production system, the print order receiver, the image forming apparatus, and the image forming method according to the present invention have been described in detail above based on various embodiments. However, the present invention is not limited to the embodiments and it is of course possible to make various modifications and design changes without departing from the gist of the present invention.

For instance, in the above description, a photo printer that obtains finished prints by imagewisely exposing a photosensitive material (printing paper) and performing wet development processing and drying the exposed photosensitive material has been described as examples of the printers 16 and 16a and the packing function-equipped mini-laboratory 16b that output prints. However, the present invention is not limited to this and as the printers that output prints, it is possible to use various other printers such as an electrophotographic printer, an ink jet printer, and a transfer printer that uses a photosensitive heat development image recording medium and transfers images to image receiving paper using an image forming solvent such as water.

Also, the above description has been made by taking, as an example, images photographed with a digital camera, a cellular phone, or the like but the present invention is not limited to this and is also applicable to a photographic film or the like as mentioned above.

What is claimed is:

1. A print production system, comprising:
a print order receiver that includes image acquiring means for acquiring first image data and input means for inputting print orders each of which is made for print production of one or more frame images of second image data among said first image data, wherein said print order receiver relates, for each print order, order information corresponding to a print order input by said input means and said second image data of said one or more frame images to each other and outputs said second image data and said order information related to each other, as well as said print order receiver has a function of selecting urgent finishing in which said print production is performed preferentially, and, when said urgent finishing is selected and outputs urgent finishing information showing that said urgent finishing has been selected by giving said urgent finishing information to said order information; and
an image forming apparatus that includes means for receiving said second image data and said order information related to each other for each print order from said print order receiver, means for performing said print production corresponding to said received order information using said received second image data, an output section for outputting one or more produced prints by said performing means, and means for enabling to identify said one or more produced prints of said print order as said urgent finishing when said one or more produced prints of said print order corresponding to said urgent finishing is output to said output section.

2. The print production system according to claim 1,
wherein said output section of said image forming apparatus includes a first output section for said urgent finishing and a second output section for ordinary finishing, and
wherein said enabling means allows to output said one or more produced prints of said print order corresponding to said urgent finishing to said first output section for said urgent finishing, thereby enabling to identify said print order as said urgent finishing.

3. The print production system according to claim 2,
wherein said image forming apparatus further includes a sorter for sorting one or more produced prints for each print order and outputting said sorted produced prints and a packer for bundling and packing said one or more produced prints for each print order and outputting said bundled and packed produced prints, and
wherein said first output section for said urgent finishing is said packer and said second output section for said ordinary finishing is said sorter.

4. The print production system according to claim 1,
wherein said image forming apparatus further performs print production of an identification print for identifying as said urgent finishing in case of said print order corresponding to said urgent finishing and
wherein said enabling means allows to output said identification print which shows that said urgent finishing has been performed together with said one or more produced prints of said print order corresponding to said urgent finishing, thereby enabling to identify said print order as said urgent finishing.

5. The print production system according to claim 1,
wherein said image forming apparatus further includes a packer for bundling and packing one or more produced prints for each print order and outputting said bundled and packed produced prints, and
wherein said packer uses a first packing bag for said one or more produced prints of said print order corresponding to said urgent finishing and a second packing bag for said one or more produced prints of said print order corresponding to ordinary finishing, which are different from each other, and
wherein said enabling means allows to output said first packing bag in which said one or more produced prints of said print order corresponding to said urgent finishing are bundled and packed and which is different from said second packing bag, thereby enabling to identify said print order as said urgent finishing.

6. The print production system according to claim 1,
wherein print production system plural print order receivers comprises said print order receiver and one or more print order receivers having a configuration as same as said print order receiver and each of said plural print order receivers outputs identification information for identification of itself by giving said identification information to said order information,
wherein said image forming apparatus outputs said one or more produced prints of said print order corresponding to said urgent finishing to said output section using said identification information so that one print order receiver that have received said print order corresponding to said urgent finishing can be distinguish from the remainder of said plural print order receivers.

7. A print production system, comprising:
plural print order receivers, each including image acquiring means for acquiring first image data and input means for inputting print orders each of which is made for print production of one or more frame images of second image data among said first image data, wherein said print order receiver relates, for each print order, order information corresponding to a print order input by said input means and said second image data of said one or more frame images to each other and outputs said second image data and said order information related to each other: and
an image forming apparatus that includes means for receiving said second image data and said order information related to each other for each print order from said print order receiver, means for performing said print production corresponding to said received order information using said received second image data, and an output section for outputting one or more produced prints by said performing means,
wherein each print order receiver outputs identification information for identification of itself by giving said identification information to said order information, and
wherein said image forming apparatus outputs said one or more produced prints of said print order to said output section using said identification information so that one print order receiver that have received said print order can be distinguish from the remainder of said plural print order receivers.

8. A print order receiver that is connected to at least one other print order receiver and at least one printer for performing production of one or more prints, comprising:
image acquiring means for acquiring first image data;
input means for inputting print production orders, each of which is made for print production of one or more frame images of second image data among said first image data;
information acquiring means for acquiring a print order status by said at least one other print order receiver connected and a print production status of said at least one printer connected;
computing means for computing, for each print order, a reception time at which said one or more produced prints corresponding to said print production order is receivable based on a content of each of said print production orders, said acquired print order status by said at least one other print order receiver, and said acquired print production status of said at least one printer; and
a display for displaying said computed reception time.

9. The print order receiver according to claim 8, further comprising:
selection means for selecting one of ordinary finishing and urgent finishing in which said print production is performed preferentially as compared with one or more print production orders of said ordinary finishing that are input at an earlier time.

10. The print order receiver according to claim 8,
wherein, after said print production order is input by said input means, processing for establishing said print production order is performed, and
wherein during a period from completion of said inputting of said print production order to said establishing of said print production order, said reception time is updated in accordance with said acquired print order status by said at least one other print order receiver and said acquired print production status of said at least one printer.

11. The print order receiver according to claim 8,
wherein while said print production order is waiting, said computing means predicts a provisional print reception time from said acquired print order status by said at least one other print order receiver and said acquired print production status of said at least one printer and displays said predicted provisional print reception time on said display.

12. An image forming apparatus, comprising:
an image forming section for producing one or more prints by recording one or more images on a recording medium in accordance with image data; and
a packer for producing a print pack by bundling and packing one or more produced prints for each order,
wherein print production by said image forming section and print pack production by said packer are controlled so that a print on a top in said print pack becomes a print on which a selected image has been recorded.

13. The image forming apparatus according to claim 12,
wherein said selected image is an image selected from among images in one print order in which production of said one or more prints is ordered.

14. The image forming apparatus according to claim 12,
wherein said selected image is an image selected from among not images in print orders in which said print production is ordered but images prepared in advance.

15. The image forming apparatus according to claim 12,
wherein said selected image is an image whose human subject face area is smallest among images containing human subjects in one print order in which production of said one or more prints is ordered.

16. The image forming apparatus according to claim 12,
wherein said selected image is an image which is selected from among images in one print order in which production of said one or more prints is ordered and does not contain a human subject.

17. The image forming apparatus according to claim 12,
wherein said selected image is an image obtained by blurring an index image of one print order in which production of said one or more prints is ordered.

18. The image forming apparatus according to claim 12,
wherein an image having undergone processing is recorded on said top print.

19. The image forming apparatus according to claim 12,
wherein said top print is a product print.

20. The image forming apparatus according to claim 12,
further comprising: a print order receiver that receives print production orders,
wherein said image forming section produces said one or more prints by recording image data supplied from said print order receiver, and
wherein said print order receiver includes means for selecting an image to be recorded on said top print in said print pack.

21. An image forming method, comprising the steps of:
producing one or more prints by recording one or more images on a recording medium in accordance with image data; and
producing a print pack by bundling and packing one or more produced prints for each order,
wherein a print on a top in said print pack becomes a print on which a selected image has been recorded.
